(19) United States
(12) Patent Application Publication
(10) Pub. No.: US 2014/0364194 A1
(43) Pub. Date: Dec. 11, 2014

(54) SERVER DEVICE AND NON-TRANSITORY COMPUTER-READABLE STORAGE MEDIUM STORING GAME PROGRAM

(71) Applicant: DeNA Co., Ltd., Tokyo (JP)

(72) Inventors: Takehiro KUSANO, Tokyo (JP); Satoru IGITA, Tokyo (JP); Shunosuke FUJISAWA, Tokyo (JP); Tatsuya NASU, Tokyo (JP)

(73) Assignee: DeNA Co., Ltd., Tokyo (JP)

(21) Appl. No.: 14/275,013

(22) Filed: May 12, 2014

(30) Foreign Application Priority Data
Jun. 11, 2013 (JP) 2013-123082

(51) Int. Cl. A63F 13/30

(52) U.S. Cl. CPC A63F 13/12
USPC 463/22

(57) ABSTRACT

A server device includes the following elements. A random selection section randomly selects a game content having a certain attribute on the basis of a predetermined winning probability. A progress processor progresses a game and calculates a progress rate of the game on the basis of a predetermined parameter. A winning probability changing processor changes, according to the attribute and a progress rate of the game calculated at a certain time point, winning probabilities of game contents after the lapse of a predetermined period from the certain time point, and sets, according to the attribute, an interval at which the winning probabilities of the game contents are changed and also sets attributes so that the attribute for which the winning probability of a corresponding game content is changed will periodically vary. A providing section provides a selected game content to the game player.

### BACKGROUND OF THE INVENTION

1. Field of the Invention

The present invention relates to a server device and a non-transitory computer-readable storage medium storing a game program.

2. Description of the Related Art

A game played by a game player by using game contents, such as game cards, is widely known. In this type of game, a game player may be able to obtain a game content. A technique for reducing the possibility, when providing a game content to a game player, that a game player will obtain the same type of game content which has already been owned by the game player is known (for example, Japanese Unexamined Patent Application Publication No. 2013-75163).

According to the technique disclosed in this publication, it is less likely that a game player will obtain the same type of game content. This increases the possibility that the game player will obtain more types of game contents, thereby enhancing the game player's interest. However, merely changing the possibility of obtaining game contents is less likely to motivate a game player to continue to play a game. For example, according to this technique, a game player who has already logged out of a game is not encouraged to log in again and to continue to play this game.

### SUMMARY OF THE INVENTION

The present invention has been made in view of this background. It is an object of the present invention to encourage a game player to continue to play a game while changing the winning probability of a game content used in this game.

According to an aspect of the present invention, there is provided a server device for controlling a game which is played by a game player via a network by using a deck in which a plurality of attributes are set in advance, the deck being organized by using a predetermined number of game contents, an attribute being set in each of the predetermined number of game contents. The server device includes: a random selection section that performs random selection to select a game content on the basis of a predetermined winning probability; a progress processor that performs processing for progressing the game and calculates a progress rate of the game played by the game player on the basis of a predetermined parameter; a winning probability changing processor that changes, in accordance with a progress rate of the game played by the game player calculated at a certain time point and in accordance with the attribute, winning probabilities of game contents after the lapse of a predetermined period from the certain time point, and that sets, according to the attribute, an interval at which the winning probabilities of the game contents are changed and also sets, among the plurality of attributes, attributes so that the attribute for which the winning probability of a corresponding game content is changed will vary in a periodical manner; and a providing section that provides a game content selected by the random selection section to the game player. A life parameter which varies in accordance with a change in a predetermined parameter of the game is set in each of the game contents. The progress processor excludes, from among a plurality of game contents forming a card group owned by the game player, a game content in which the life parameter is reduced to a predetermined value or lower from the card group. On the basis of the winning probability set for an attribute of the excluded game content, the winning probability changing processor performs random selection to select a game content having the attribute of the excluded game content in response to a request from the game player. The providing section provides the selected game content to the game player.

The other features of the present invention will become apparent from the description of the specification and the accompanying drawings.

According to an embodiment of the present invention, it is possible to encourage a game player to continue to play a game while changing the winning probability of a game content used in this game.

### BRIEF DESCRIPTION OF THE DRAWINGS

FIG. 1 illustrates an example of the overall configuration of a game system according to an embodiment of the present invention;

FIG. 2 is a block diagram illustrating an example of the functional configuration of a server device according to this embodiment of the present invention;

FIG. 3 is a block diagram illustrating an example of the functional configuration of a game player terminal according to this embodiment of the present invention;

FIG. 4 is a table illustrating an example of the data structure of card information;

FIG. 5 illustrates a table illustrating an example of the data structure of cards owned by a game player;

FIG. 6 is a table illustrating an example of the data structure of a deck (game card group) organized by a game player;

FIG. 7 illustrates a table illustrating an example of the data structure of game player information concerning a game player in a game;

FIGS. 8A and 8B illustrate the winning probabilities of game cards used for performing random selection;

FIG. 9 illustrates the winning probabilities of game cards corresponding to individual attributes;

FIGS. 10A through 10G illustrate a case in which the winning probability of a game card of each attribute is periodically changed;

FIG. 11 is a flowchart illustrating an operation for providing a game content; and

FIG. 12 illustrates an example of a result notifying screen.

### DESCRIPTION OF THE PREFERRED EMBODIMENTS

At least the following configurations will become apparent from the specification and the accompanying drawings.

There is provided a server device for controlling a game which is played by a game player via a network by using game contents in a game space. The server device includes: a random selection section that performs random selection to select a game content on the basis of a predetermined winning probability; a progress processor that performs processing for progressing the game and calculates a progress rate of the game played by the game player on the basis of a predetermined parameter; and a winning probability changing processor that changes, in accordance with a progress rate of the game played by the game player calculated at a certain time point, winning probabilities of game contents after the lapse of a predetermined period from the certain time point.

In this server device, it is possible to encourage a game player to continue to play a game while changing the winning probabilities of game contents used in the game.

In the above-described server device, an attribute may be set in each of the game contents, and the winning probability changing processor may change the winning probabilities of the game contents according to the attribute.

In this server device, a game player is more likely to obtain a game card of a desired attribute and thus, it is possible to enhance the game player's interest in the game.

In the above-described server device, the winning probability changing processor may set, according to the attribute, an interval at which the winning probabilities of the game contents are changed.

In this server device, it is easy to understand at which timing and for which attribute the winning probability of a game card will be changed, thereby making it possible to encourage a game player to log in and to continue to play a game while enhancing the game player's interest in the game.

In the above-described server device, the winning probability changing processor may set, among the attributes, attributes so that the attribute for which the winning probability of a corresponding game content is changed will vary in a periodical manner.

In this server device, a game player is more likely to obtain a game content of a desired attribute. This also makes the game player who has logged in a game feel like logging in again the following day, thereby making it possible to encourage the game player to log in and to continue to play the game.

The server device may further include a providing section that provides a game content selected by the random selection section to the game player. A life parameter which varies in accordance with a change in a predetermined parameter of the game may be set in each of the game contents. The progress processor may exclude, from among a plurality of game contents forming a card group owned by the game player, a game content in which the life parameter is reduced to a predetermined value or lower from the card group. On the basis of the winning probability set for an attribute of the excluded game content, the winning probability changing processor may perform random selection to select a game content having the attribute of the excluded game content in response to a request from the game player. The providing section may provide the selected game content to the game player.

In this server device, it is possible to efficiently replace a game content excluded from a card group of a game player by a new game content.

The server device may further include an image data generator that generates data of an image indicating an attribute of a game content for which the winning probability will be changed after the lapse of a predetermined period from the certain time point and causes a game player terminal to be operated by the game player to display the image before the winning probability is changed.

In this server device, by checking information concerning a change in the winning probability on a screen, a game player can understand at which timing the progress rate of the game has to be enhanced.

There is also provided a non-transitory computer-readable storage medium storing a game program which causes an information processing apparatus to execute a game which is played by a game player via a network by using game contents in a game space. The game program causes the information processing apparatus to execute: performing random selection to select a game content on the basis of a predetermined winning probability; performing processing for progressing the game and calculating a progress rate of the game played by the game player on the basis of a predetermined parameter; and changing, in accordance with a progress rate of the game played by the game player calculated at a certain time point, winning probabilities of game contents after the lapse of a predetermined period from the certain time point.

Configuration of Game System 1

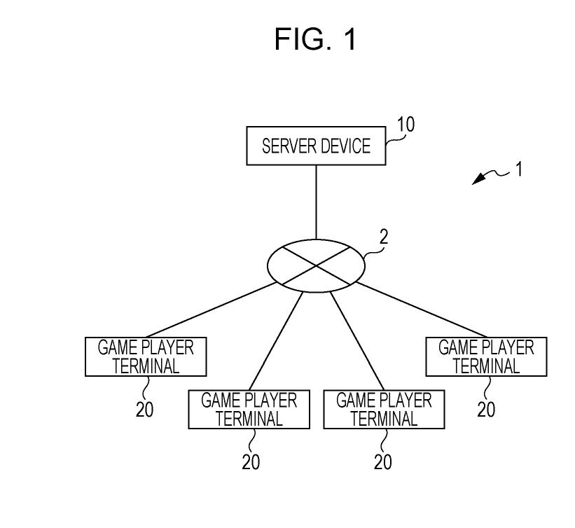

FIG. 1 illustrates an example of the overall configuration of a game system 1 according to an embodiment of the present invention.

The game system 1 provides various services concerning games (such as social games) to users (hereinafter may also referred to as “game players”) via a network 2. The game system 1 includes a server device 10 and a plurality of game player terminals 20. The server device 10 and the game player terminals 20 are connected to the network 2 so that they can communicate with the network 2.

A game player accesses the game system 1 by using a game player terminal 20 so that he/she can play a game transmitted from the server device 10 via the network 2. A game player is also able to communicate with other game players by accessing the game system 1.

Server Device 10

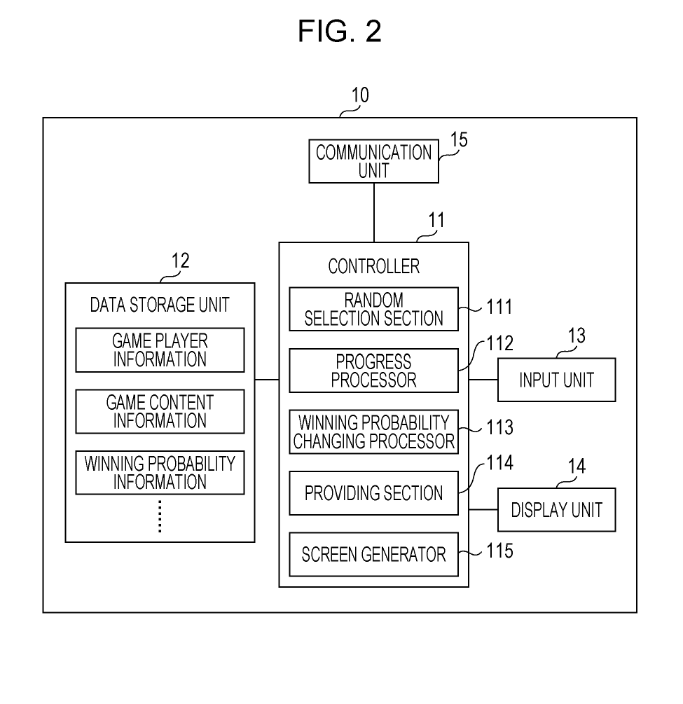

FIG. 2 is a block diagram illustrating an example of the functional configuration of the server device 10. The server device 10 is an information processing apparatus (for example, a workstation or a personal computer) used by, for example, a system administrator, when operating and administrating game services. Upon receiving various commands (requests) from a game player terminal 20, the server device 10 is able to distribute a game program which is operable in the game player terminal 20 or a web page created with a markup language (such as HTML) which matches the standards of the game player terminal 20. The server device 10 of this embodiment includes a controller 11, a data storage unit 12, an input unit 13, a display unit 14, and a communication unit 15.

The controller 11 allows the individual elements of the server device 10 to send and receive data therebetween and also controls the entire server device 10. The controller 11 includes a random selection section 111, a progress processor 112, a winning probability changing processor 113, a providing section 114, and a screen generator 115. Specific operations of the individual elements will be discussed later.

The data storage unit 12 includes a read only memory (ROM), which is a read-only storage region in which a system program is stored, and a random access memory (RAM), which is a programmable storage region used as a work area by the controller 11 for executing arithmetic processing. The data storage unit 12 may be implemented by a non-volatile storage device, for example, a flash memory or a hard disk. In the data storage unit 12 of this embodiment, information concerning game contents (for example, game cards) used in a game is stored. The data storage unit 12 also stores therein information concerning the statuses of the game player terminals 20 concerning this game, information concerning game contents used in this game owned by the game player terminals 20, information concerning the winning probabilities of game contents, and other items of information. The data structures of these items of information will be discussed later.

The input unit 13 is used by, for example, a system administrator, for inputting settings concerning various items of data and a game (for example, conditions for setting a special area, which will be discussed later). The input unit 13 may be implemented by, for example, a keyboard and a mouse.

The display unit 14 displays an operation screen for a system administrator in response to an instruction from the controller 11. The display unit 14 may be implemented by, for example, a liquid crystal display (LCD).

The communication unit 15 communicates with the game player terminals 20, and has a function as a receiver for receiving various items of data and signals transmitted from the game player terminals 20 and a function as a transmitter for transmitting various items of data and signals to the game player terminals 20 in response to an instruction from the controller 11. The communication unit 15 may be implemented by a network interface card (NIC).

Game Player Terminal 20

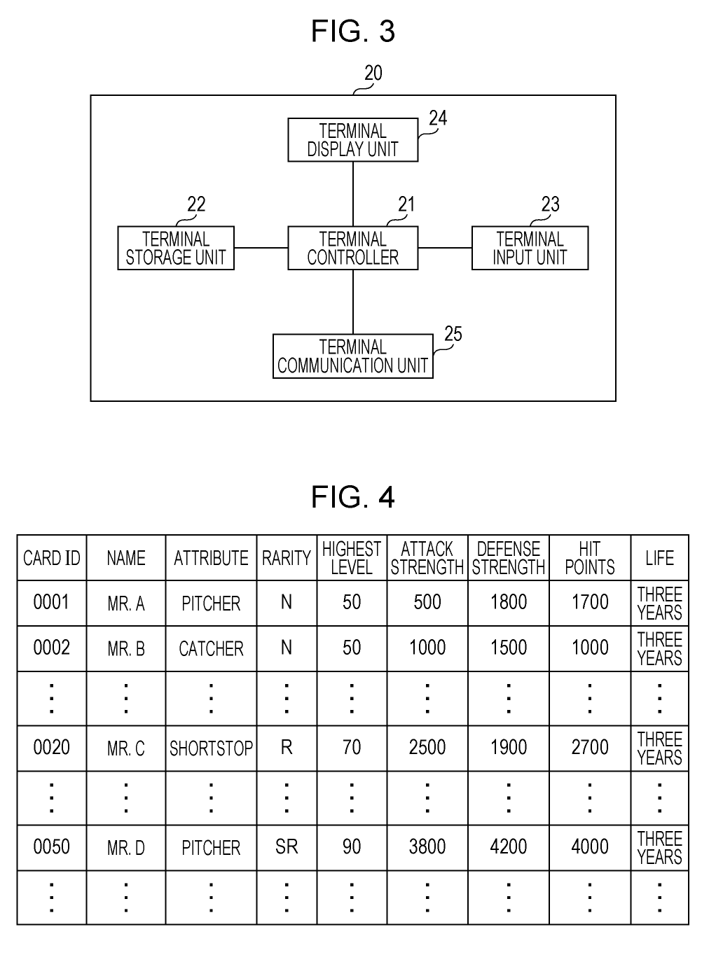

FIG. 3 is a block diagram illustrating an example of the functional configuration of a game player terminal 20. The game player terminal 20 is an information processing terminal operated by a game player (user) when playing a game. The game player terminal 20 is, for example, a cellular phone terminal, a smartphone, a personal computer, or a game machine, and sends and receives information to and from the server device 10 that the game player terminal 20 can access via the network 2. The game player terminal 20 of this embodiment includes a terminal controller 21, a terminal storage unit 22, a terminal input unit 23, a terminal display unit 24, and a terminal communication unit 25.

The terminal controller 21 allows the individual elements of the game player terminal 20 to send and receive data therebetween, and also controls the entire game player terminal 20. The terminal controller 21 is implemented by a central processing unit (CPU) by executing a program stored in a predetermined memory. The terminal controller 21 of this embodiment also serves as a screen display controller for controlling a display mode of a game screen displayed in the terminal display unit 24.

The terminal storage unit 22 is connected to the terminal controller 21 via a bus, and refers to, reads, and rewrites data stored in the terminal storage unit 22 in response to an instruction from the terminal controller 21. The terminal storage unit 22 may be implemented by, for example, a flash memory or a hard disk.

The terminal input unit 23 is used by a game player for performing various operations (a game operation or a text input operation), and is implemented by, for example, operation buttons or a touch panel.

The terminal display unit 24 is used for displaying a game screen (such as a map screen, which will be discussed later) generated on the basis of game information in response to an instruction from the terminal controller 21. The terminal display unit 24 is implemented by, for example, an LCD.

The terminal communication unit 25 communicates with the server device 10, and has a function as a receiver for receiving various items of data and signals transmitted from the server device 10 and a function as a transmitter for transmitting various items of data and signals to the server device 10 in response to an instruction from the terminal controller 21. The terminal communication unit 25 may be implemented by a NIC.

Overview of Game

An overview of a game provided by the game system 1 will be discussed below.

In the game system 1 of this embodiment, a competition game played by using game contents can be provided to a game player (user). A baseball card game played by using game cards, which are examples of game contents, will be described below. These game cards are virtual cards used in a virtual game space since they are game cards as digital contents.

Baseball Card Game

In the game system 1 of this embodiment, the following baseball game is provided. A game card group organized by a game player plays a baseball match against a game card group of another game player, which is a competitor, or a computer, and aims to win in a championship match held in a game.

In the baseball card game of this embodiment, a game player first organizes a team for playing a match. A team for playing a match is constituted by nine baseball players (that is, nine game cards). The game player selects nine game cards from among a plurality of game cards owned by the game player so as to organize a game card group corresponding to a “team”. This game card group will also be referred to as a “deck”. The number of game cards forming a deck is not restricted to nine, and another player, such as a pinch hitter, may be included in a deck.

An attribute (position in a baseball game) is set in each game card. When setting, for example, a “pitcher” in a deck, one of game cards having an attribute “pitcher” is selected and set from among a plurality of game cards owned by a game player. Similarly, when setting, for example, “outfielders” in a deck, three game cards having an attribute “outfielder” are selected and set from among a plurality of game cards owned by the game player.

After organizing a deck (team), the game player is able to play a match by using this deck against a deck (team) of another game player or a computer. The victory or the defeat of a match is determined on the basis of parameters set for the individual game cards forming a deck. For example, the victory or the defeat may be determined by comparing the total attack strength of game cards forming a deck of attack players with the total defense strength of game cards forming a deck of defense players.

Matches include practice matches and championship matches. Predetermined experience points can be gained in accordance with the scales, results, and contents (for example, a team won a match against a competitor team by how many points) of these matches. As a team wins in a bigger match, more experience points can be gained. By accumulating experience points, a game player is promoted to a higher rank. In this embodiment, as the rank of a game player is higher, the upper limit value of a parameter is advantageously increased, and also, the winning probability of a game card is advantageously increased. A rank of a game player may be updated in accordance with experience points gained during a certain period (for example, during a week in the real world), or may be determined by comparing the experience points of this game player with those of another game player. Additionally, even between the same ranks of teams, the strength of a deck may be set to differ in accordance with, for example, the gained experience points.

By practicing as well as playing a match, the level of a game card may be increased or experience points may be gained. That is, as a game player logs in more times to play a game or to practice more, this game player is able to take the initiative to play a game in an advantageous manner.

In the baseball card game of this embodiment, a time concept in a game world (hereinafter referred to as a “virtual game time”) is defined. For example, one week in terms of the time in the real world corresponds to one year in terms of the virtual game time. In each game card, parameters concerning the virtual game time are set. An example of such parameters set in a game card is a life parameter. The life parameter is decreased with the passage of the virtual game time, and when the life parameter is reduced to zero after the lapse of a predetermined virtual game time, this game card is disabled and is excluded from a game card group owned by the game player. That is, each game card can be used as a baseball player only during a predetermined period.

For example, if a school activity (school baseball club) is assumed as a setting of the baseball card game, this baseball club team aims to win in a big championship during a certain period (three years in terms of the virtual game time) for which a certain baseball player (for example, an ace pitcher) is being at school. Then, after the lapse of three years in terms of the virtual game time, this player graduates from the school and leaves the club team. That is, the life parameter of the game card is reduced to zero and this game card is excluded from the deck. Accordingly, it is necessary to reorganize a deck (team) by using another player (different game card) as a new ace pitcher for the subsequent years.

The life parameter may be decreased, not only in accordance with the passage of the virtual game time, but also in accordance with another factor.

Data Configuration

A description will now be given of a data configuration representing various items of information used in the game system 1 of this embodiment. The data storage unit 12 of the server device 10 stores therein various items of information, such as card information concerning game cards, which serve as game contents, game player card information concerning cards owned by each game player, deck information concerning a deck organized by each game player, game player information concerning the status of each game player, and winning probability information for defining the winning probability of each attribute.

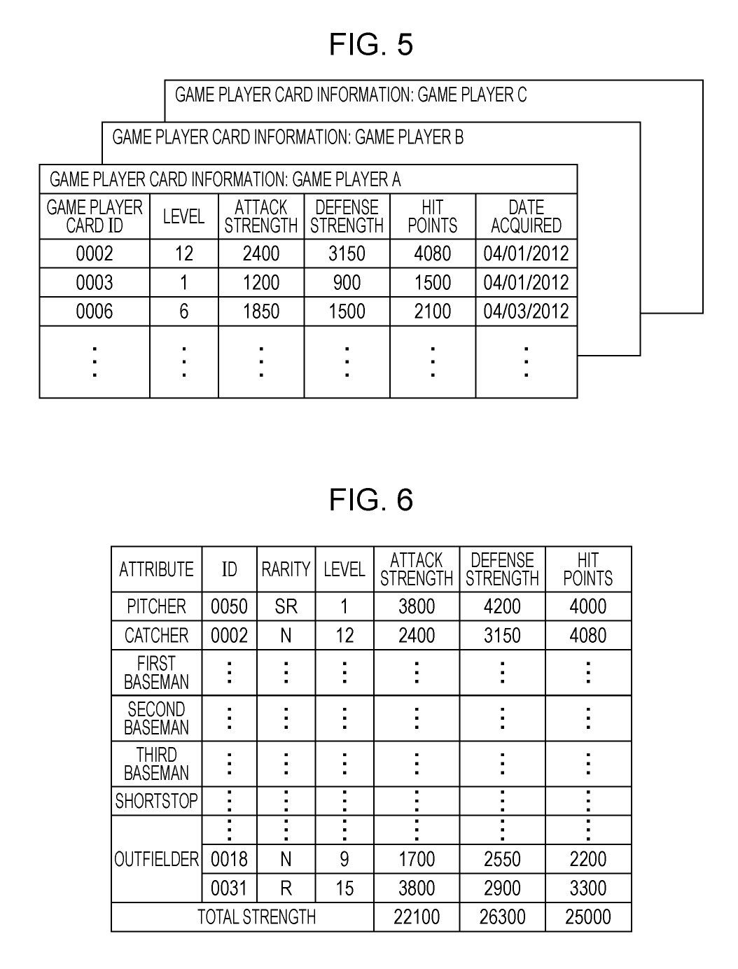

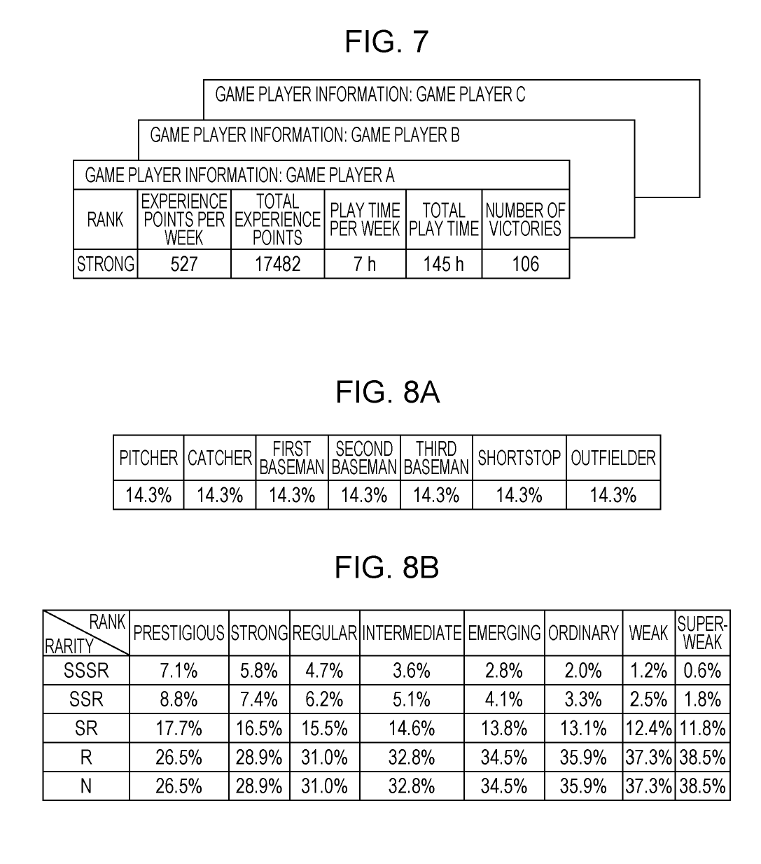

FIG. 4 is a table illustrating an example of the data structure of card information. FIG. 5 illustrates a table illustrating an example of the data structure of cards owned by a game player (game player card information). FIG. 6 is a table illustrating an example of the data structure of a deck (game card group) organized by a game player (deck information). FIG. 7 illustrates a table illustrating an example of the data structure of game player information concerning a game player in a game.

(Card Information)

The card information is constituted by a card ID, which is an example of identification information for identifying a game card, and various items of information concerning this game card associated with the card ID. The card information indicates, for example, as shown in FIG. 4, the name of a character (name of a player) corresponding to the game card, the attribute (position in a baseball match) of the game card, the highest level, and various parameters (initial parameters), such as the attack strength, the defense strength, and hit points at the initial level. Additionally, the above-described life parameter is set in each game card. In addition to these items of information, other items of information, such as the rarity of a game card and skills (special abilities) demonstrated during a match, may be included. Generally, as the rarity of a game card is higher, various parameters set for this game card are higher, and this game card is stronger.

(Game Player Card Information)

The game player card information is information indicating a game card owned by a game player (may be simply referred to as a “game player card”). Each game card has parameters unique to this card, and the parameters are stored in the data storage unit 12 in association with the ID of a corresponding game card. The game player card information indicates, for example, as shown in FIG. 5, the game player card ID of a game card, the level of a player corresponding to this game card, and various parameters, such as the attack strength, the defense strength, and hit points at this level. The various parameters, such as the attack strength, may be calculated from the initial parameters (see FIG. 4) of the game card recorded as the card information and also from the level of the game card at a current time point. The game player card information includes information concerning the date on which a game player acquired this game card. The life parameter of each game card may be set to vary on the basis of this date information and the passage of time in the game. For example, if a school activity is assumed as a setting of the baseball card game, as described above, the life parameter is reduced to zero (a player graduates from the school) after the lapse of three years in terms of the virtual game time since this game card was acquired (since the player entered the school). If the life parameter is reduced to zero, the game card concerning this player is excluded from the game player card information.

(Deck Information)

The deck information is information indicating a competition game card group organized as a team as a result of a game player selecting game cards from game cards owned by the game player. A game player organizes a deck by selecting a predetermined number of game cards concerning each attribute, as shown in FIG. 6. In the baseball card game of this embodiment, a game player sets one game card (player) concerning each of the attributes, that is, a pitcher, a catcher, a first baseman, a second baseman, a third baseman, and a shortstop. The game player also sets three game cards concerning an attribute, that is, an outfielder. As a result, a team consisting of nine players is formed. Then, the total strength of the deck organized by the game player is calculated on the basis of the parameters set for these nine game cards. That is, a team having more game cards having higher parameters (that is, more excellent players) is able to take the initiative to play a competition (such as a match) in a more advantageous manner.

In addition to game cards corresponding to the nine players, a game card corresponding to a manager or a coach may be set, or a game card having a special skill may be set.

(Game Player Information)

The game player information is information concerning the statuses of game players in a game. The game player information indicates, for example, as shown in FIG. 7, the rank, experience points, the game play time, and the number of victories in matches of a game player at a current time point. These items of information are referred to when the progress rate of this game played by a game player is calculated. The progress rate will be discussed later.

(Winning Probability Information)

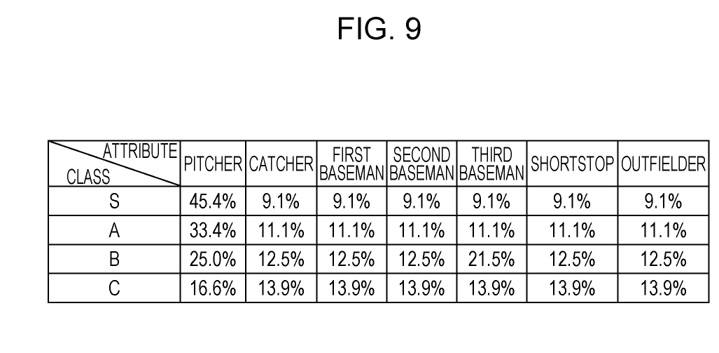

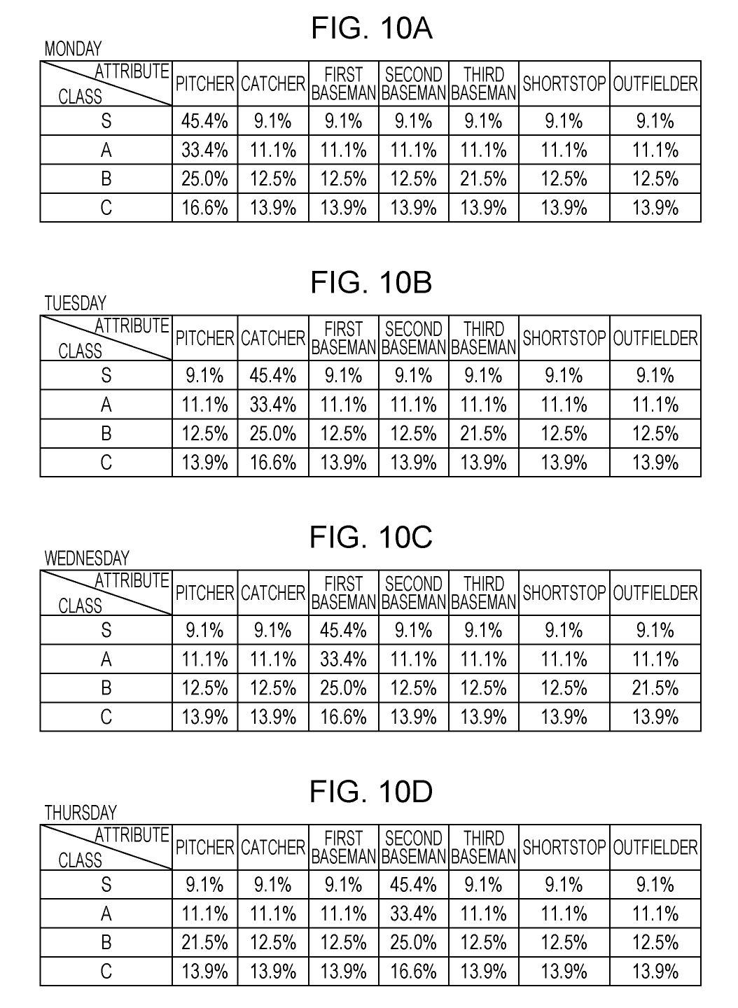

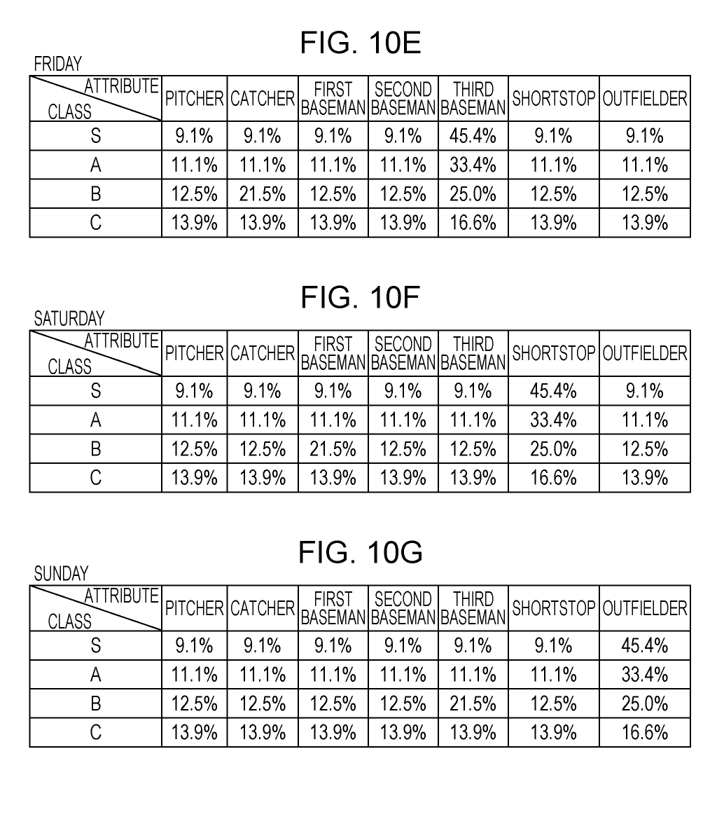

The winning probability information is information for defining the winning probability of a game card that a game player is likely to gain. The winning probability information will be discussed later with reference to FIGS. 9 and 10G.

Obtaining of Game Content

A description will be given below of how to obtain a game content (game card) by a game player. A game card (game content) used in a game in this embodiment is provided to each game player by the providing section 114 of the server device 10. A game card is provided to a game player mainly by a technique “random selection”. In this embodiment, random selection is performed in response to a request from a game player. More specifically, a game card is extracted from a plurality of game cards on the basis of a predetermined probability, and the extracted game card is provided to a game player and is added to the game player card information of this game player. Random selection of a game card is performed by the random selection section 111 of the controller 11.

FIGS. 8A and 8B illustrate the winning probabilities of game cards employed when performing random selection. In the case of a baseball card game, such as that in this embodiment, game cards corresponding to seven attributes (positions) are set (see FIG. 6), and, generally, the probability of extracting a game card of one attribute is 14.3% ( 1/7). In other words, a game card of any attribute will be selected with the same probability. For example, even if a game player wishes to obtain a game card having an attribute “pitcher”, the probability that the game player will obtain this type of game card by means of random selection is 14.3% (see FIG. 8A). If the rarity is set in a game card, the winning probability of this game card is changed according to the rarity. Generally, a lower winning probability is set for a game card having a higher rarity. Additionally, in this embodiment, a game player having a higher rank is more likely to obtain a game card having a higher rarity. For example, it is now assumed that there are eight ranks from a “prestigious” rank to a “super-weak” rank, as shown in FIG. 8B. In the case of a game player classified as a super-weak rank, which is the lowest rank, the winning probability for obtaining a highest-rarity SSSR game card is as low as 0.6%. In contrast, in the case of a game player classified as a prestigious rank, which is the highest rank, the winning probability for obtaining a highest-rarity SSSR game card is as high as 7.1%, and such a game player is more likely to obtain a high-rarity game card. That is, as a game player is promoted to a higher rank by gaining more experience points, this game player is more likely to obtain a higher-rarity game card.

Changing of Winning Probability

In this embodiment, when random selection is performed, as the rank of a game player is higher, this game player is more likely to obtain a higher-rarity card. On the other hand, however, even if the rank of a game player is high, it is still difficult to obtain a game card having an attribute that this game player wishes to obtain. This is because the winning probability of obtaining a game card having a certain attribute is basically the same as that for obtaining a game card having another attribute (see FIG. 8A), and the probability of obtaining a game card having an attribute that the game player wishes to obtain is still the same as that of obtaining a game card having another attribute. If the game player has failed to obtain a desirable game card for a long time, this game player may lose his/her interest in the game. In particular, as in a game, such as in the baseball card game of this embodiment, if a player (game card) has become unusable with the passage of time because the life parameter is reduced to zero, it is necessary to replace this unusable card by a new game card (player) in a deck. In this case, if it is difficult to obtain a game card of a desired attribute, it is not possible to sufficiently fill in an empty position, and thus, a game player may give up continuing the game.

Accordingly, in this embodiment, the winning probabilities of game cards are changed according to the attribute. This makes it easier for a game player to obtain a game card of a desired attribute. Additionally, in order to encourage a game player to log in and to continue to play a game, the winning probability of a game card is changed in accordance with the progress rate of a game.

FIG. 9 illustrates the winning probabilities of game cards corresponding to the individual attributes in this embodiment. The winning probability changing processor 113 changes the winning probabilities of game cards according to the attribute. For example, the winning probability changing processor 113 changes the winning probabilities so that the winning probability of a game card of a certain attribute will be higher than that of a game card of another attribute. In the example shown in FIG. 9, the winning probabilities are changed so that the winning probability of a game card of a pitcher will be higher than the winning probabilities of game cards of other attributes. When the winning probability of a game card of a certain attribute is changed, data indicating a screen (not shown) for informing game players of such a change (in the example in FIG. 9, the winning probability of a game card of a pitcher is increased) is generated by the screen generator 115, and is displayed in the terminal display unit 24 of the game player terminal 20. A game player checks this screen and sends a request to perform random selection when the winning probability of a game card of an attribute that the game player wishes to obtain has become high. This makes it easier for the game player to obtain a game card of this attribute.

Additionally, in this embodiment, even for game cards of the same attribute, the winning probability is changed on the basis of the progress rate of a game played by a game player. The progress rate of a game is determined on the basis of predetermined parameters concerning a game. While allowing a game to progress, the progress processor 112 of the controller 11 calculates the progress rate of the game played by a game player on the basis of the predetermined parameters. Examples of the predetermined parameters are the number of practice matches performed by a game player and a time for which the game player plays this game during a certain period. By referring to such parameters, the progress rate of the game is calculated. The period used for calculating the progress rate may be one day or several hours from the morning to the night in terms of the time in the real world.

In FIG. 9, the progress rate is represented by a class. The winning probability changing processor 113 changes the winning probabilities so that, as the class of a game player is higher, that is, the progress rate calculated at a certain time point is higher, the winning probability of a game card of a specific attribute for this game player is increased. For example, if the winning probability of a game card of a pitcher is higher than the winning probabilities of game cards of other attributes, the winning probabilities are changed so that, as the class of a game player is higher, the winning probability of a game card of a pitcher for this game player is higher than the winning probabilities of game cards of the other attributes. In the example shown in FIG. 9, for game players of the lowest class C, the winning probability of a game card of a pitcher is 16.6%, while the winning probabilities of game cards of the other attributes are 13.9%. In this manner, the difference between the winning probability of a game card of a pitcher and the winning probabilities of game cards of the other attributes is small. In contrast, for game players of the highest class S, the winning probability of a game card of a pitcher is 45.4%, while the winning probabilities of game cards of the other attributes are 9.1%. In this manner, the probability that a game card of a pitcher will be selected is very high.

The timing at which the winning probability is actually changed is after the lapse of a certain period from a certain time point at which the progress rate was calculated. For example, on the basis of the progress rate calculated today, the winning probability of a game card will be changed tomorrow.

With this arrangement, a game player is more likely to obtain a game card of a desired attribute. For example, if a game player wishes to obtain a game card of a pitcher, the game player enhances the progress rate, for example, playing many practice matches in advance, and then, when the winning probability of a game card of a pitcher is increased after the lapse of a predetermined time, the game player sends a request to perform random selection. In order to facilitate this operation, information concerning when and how much the winning probability of a game card of a certain attribute will be changed may be displayed on a game screen. By checking information concerning a change in the winning probability on a game screen, a game player can understand at which timing the progress rate of the game has to be enhanced. Additionally, the game progress rate (in the example in FIG. 9, the class) of each game player is displayed on a game screen (for example, a my-page screen). Accordingly, a game player can more easily identify the winning probability applied to oneself.

With this technique, a game player can more easily understand that, if the game player logs in a game and enhances the progress rate of this game in advance, the winning probability of a game card of a predetermined attribute will be increased. Then, at a timing at which the winning probability of a game card of a desired attribute is increased, the game player logs in the game again and sends a request to perform random selection. In this manner, the game player is more likely to obtain a desired game card. As a result, it is possible to encourage the game player to log in and to continue to play a game.

Periodical Change of Winning Probability

In this embodiment, the winning probabilities of game cards may be periodically changed. That is, the winning probabilities of game cards of individual attributes (individual positions, such as a pitcher, a catcher, and an outfielder) may be changed at predetermined regular intervals.

FIGS. 10A through 10G illustrate a case in which the winning probability of a game card of each attribute is periodically changed. In the example shown in FIGS. 10A through 10G, the winning probabilities of game cards of seven attributes (positions) are changed at regular intervals (one week). More specifically, the winning probabilities of the individual attributes are changed as follows. The winning probability of a pitcher is increased on Monday, the winning probability of a catcher is increased on Tuesday, the winning probability of a first baseman is increased on Wednesday, the winning probability of a second baseman is increased on Thursday, the winning probability of a third baseman is increased on Friday, the winning probability of a shortstop is increased on Saturday, and the winning probability of an outfielder is increased on Sunday. Then, the winning probability of a pitcher is increased again on Monday one week later. That is, the winning probability of a game card of a predetermined attribute is changed on the same day of every week. In this case, the winning probability changing processor 113 sets, according to the attribute, an interval at which the winning probability of a game card is changed. In this manner, by periodically changing the winning probability of a game content according to the attribute, a game player can more easily understand at which timing and for which attribute the winning probability of a game card will be changed.

As described above, in the baseball card game of this embodiment, the progress rate of a game played by a game player is calculated, and the winning probability is changed in accordance with the calculated progress rate. This makes it easier for a game player to obtain a game card of a desired attribute. For example, if a game player wishes to obtain a game card of a pitcher, since the winning probability of a game card of a pitcher is increased every Monday, the game player enhances the progress rate of the game, for example, by playing a practice match, on Sunday, which is the previous day. Then, the game player sends a request to perform random selection the following day, which is Monday. In this manner, the game player is more likely to obtain a game card of a pitcher than sending a request to perform random selection on the other days of the week, and also to obtain a higher-rarity game card in accordance with the progress rate of the game. That is, the result of making an effort to progress a game on the previous day by a game player is reflected in the winning probability the following day. Accordingly, the game player can be encouraged to log in again the following day.

In the example shown in FIGS. 10A through 10G, the winning probabilities of game cards of all the attributes are changed at the same interval (one week). However, the interval at which the winning probability is changed may differ depending on the attribute. For example, the winning probability of a game card of a pitcher may be changed every day, and the winning probability of a game card of a catcher may be changed every three days.

In this embodiment, the winning probability changing processor 113 sets, among the attributes of the game cards, attributes so that the attribute for which the winning probability of a game card is increased will vary in a periodical manner. In the example shown in FIGS. 10A through 10G, the winning probability of a game card of a pitcher is increased every Monday, the winning probability of a game card of a catcher is increased every Tuesday, the winning probability of a game card of a first baseman is increased every Wednesday, the winning probability of a game card of a second baseman is increased every Thursday, the winning probability of a game card of a third baseman is increased every Friday, the winning probability of a game card of a shortstop is increased every Saturday, and the winning probability of a game card of an outfielder is increased every Sunday. By setting attributes so that the attribute for which the winning probability of a game card is increased will vary in a periodical manner (in the example in FIGS. 10A through 10G, at the interval of every week), a game player is more likely to obtain a game card of a desired attribute. For example, if a game player wishes to obtain game cards of a catcher and a shortstop, it is more likely to obtain game cards of such desired attributes if random selection is performed on Tuesday when the winning probability of a game card of a catcher is higher and on Saturday when the winning probability of a game card of a shortstop is higher. Accordingly, the game player willingly logs in the game on Monday, which is the previous day of Tuesday, and on Friday, which is the previous day of Saturday, and enhances the progress rate of the game, for example, by playing many practice matches, in advance, thereby increasing the winning probability of game cards of the desired attributes.

In the baseball card game of this embodiment, since the life parameter is set in game cards, the above-described technique for periodically changing the winning probabilities of game cards according to the attribute is particularly effective. For example, if a school activity (baseball club) is assumed as a setting of the baseball card game, an ace pitcher, no matter how strong he is, (that is, a game card having high parameters), graduates from a school after the lapse of three years in terms of the virtual game time and is excluded from a deck. In this case, a new player (game card) is required to be filled in a position (attribute) of the excluded ace pitcher. If the attribute for which the winning probability of a game card is increased varies in a periodical manner, a player (game card) having a position (attribute) of an excluded player can be efficiently obtained. Additionally, the strength of a deck can also be enhanced efficiently since the possibility that a game card can be obtained according to the position (attribute) is high.

It is now assumed that there is a game player who logged in a game and enhanced the progress rate of the game the previous day and logs in again the following day to send a request to perform random selection. In this case, information that the winning probability of a game card of another attribute will be increased the following day is provided to this game player. This makes the game player feel like logging in again one more day and encourages the game player to continue to play the game.

Flow of Providing Game Content

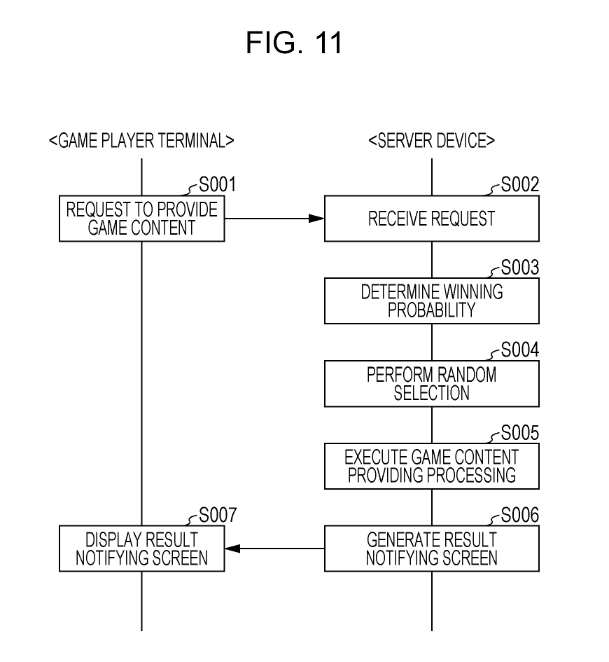

A specific operation for providing a game content (game card) will be briefly described below with reference to the flowchart of FIG. 11.

First, in step S001, a game player who wishes to obtain a game card makes a request to provide a game content (that is, a request to perform random selection) by using the game player terminal 20. In step S002, the server device 10 receives this request via the network 2. In step S003, upon receiving a request to perform random selection, the server device 10 determines the winning probability. The controller 11 of the server device 10 accesses the game player information and the winning probability information stored in the data storage unit 12 and reads information necessary to determine the winning probability. More specifically, the controller 11 reads the winning probability information based on the rank of this game player at a current time point, the progress rate of the game calculated by the progress processor 12, and the winning probability changed by the winning probability changing processor 13, and then determines the winning probability on the basis of the read winning probability information. Then, in step S004, the random selection section 111 performs random selection to select a game card.

Then, in step S005, the server device 10 executes processing for providing the extracted game card to the game player. The providing section 114 adds the selected game card to the game player card information and stores it. With this operation, the game player obtains a new game card.

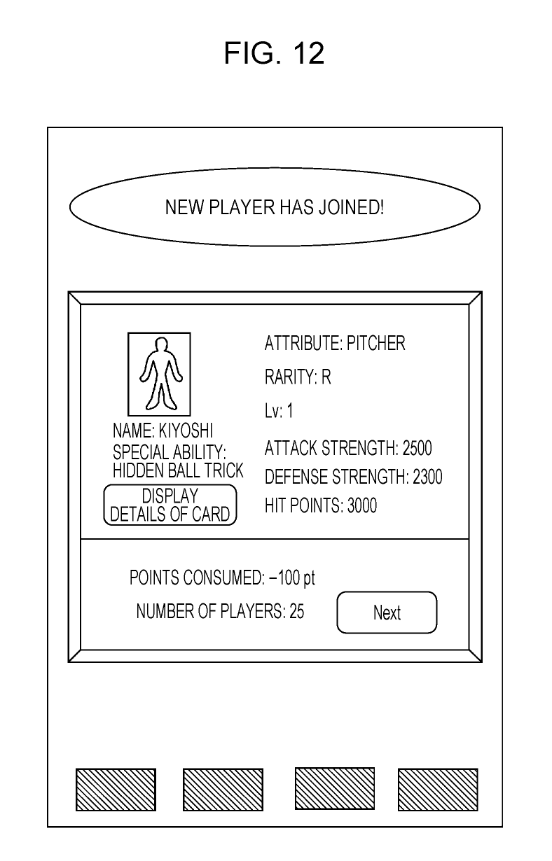

After a game card is randomly selected, in step S006, the screen generator 115 generates data indicating a result notifying screen for notifying the game player of selection results. FIG. 12 illustrates an example of the result notifying screen. On the result notifying screen, information concerning a game card obtained by a game player by performing random selection is displayed. For example, as the information concerning the game card, the attribute (position), the rarity, and the initial parameters are displayed. Additionally, other items of information, such as points consumed for performing random selection (random selection points), the price billed, and the number of game cards currently owned by the game player may also be displayed. The data indicating the generated result notifying screen is sent to the game player terminal 20. In step S007, the result notifying screen is displayed in the terminal display unit 24. The game player sees this screen so that he/she can check the new game card obtained through random selection.

As described above, in this embodiment, it is possible to encourage a game player to continue to play a game while enhancing the game player's interest by changing the winning probability of a game card.

### Other Embodiments

The above-described embodiment of the present invention has been provided in order to enhance the better understanding of the invention. It is not intended to be exhaustive or to limit the invention to the precise forms disclosed. The present invention may be modified and improved without departing from the spirit of the invention, and also, equivalents of the present invention are also encompassed within the invention. The following embodiments are also encompassed within the present invention.

Baseball Card Game

In the above-described embodiment, a baseball card game has been discussed as an example of a game that a game player can be encouraged to log in and to continue to play. However, the type of game is not restricted to a baseball card game. This embodiment is also applicable to another type of game, for example, a racing game for performing car racing against other competitors. In this case, game contents (game cards) are not players, but car parts, and attributes corresponding to types of car parts are set. As the life parameter is reduced, car parts are worn more. In this type of game, too, by changing the winning probabilities of game contents used in a game, it is possible to encourage a game player to log in and to continue to play a game.

Life Parameter

In the above-described embodiment, the life parameter which is reduced with the passage of a virtual game time has been discussed as an example of parameters set in a game card (game content). However, the life parameter may be changed in accordance with a factor other than the passage of a virtual game time. For example, an event, such as taking a leave of absence from school or studying abroad, may occur during a game, and upon the occurrence of such an event, a decrease in the life parameter may be stopped or recovered. Conversely, upon the occurrence of an event, such as an injury, the life parameter may be reduced.

In a racing game, if maintenance is conducted, the life parameter of a car part may be recovered, or if a car crash takes place during a race, the life parameter of a car part may be reduced.

Information Processing Apparatus

In the above-described embodiment, the game system 1 including the single server device 10, which is an example of an information processing apparatus, has been discussed. However, the game system 1 may include a plurality of server devices 10 as the information processing apparatus. That is, the plurality of server devices 10 are connected to each other via the network 2 and the individual server devices 10 may perform various processing operations in a distributed manner.

Some of the functions of the information processing apparatus may be performed by the game player terminals 20. In this case, the server device 10 and the game player terminals 20 form the information processing apparatus.

Game Program

In the game system 1 of the above-described embodiment, operations for encouraging a game player to log in and to continue to play a game while changing the winning probability of a game content used in a game by operating the server device 10 and the game player terminals 20 in cooperation with each other have been discussed by way of example. A game program for causing the server device 10 and the game player terminals 20 to execute these operations is also encompassed within the present invention. That is, the server device 10, which serves as an information processing apparatus, and the game player terminals 20 may execute the above-described operations on the basis of the game program.

What is claimed is:

1. A server device for controlling a game which is played by a game player via a network by using a deck in which a plurality of attributes are set in advance, the deck being organized by using a predetermined number of game contents, an attribute being set in each of the predetermined number of game contents, the server device comprising:
a random selection section that performs random selection to select a game content on the basis of a predetermined winning probability;
a progress processor that performs processing for progressing the game and calculates a progress rate of the game played by the game player on the basis of a predetermined parameter;
a winning probability changing processor that changes, in accordance with a progress rate of the game played by the game player calculated at a certain time point and in accordance with the attribute, winning probabilities of game contents after the lapse of a predetermined period from the certain time point, and that sets, according to the attribute, an interval at which the winning probabilities of the game contents are changed and also sets, among the plurality of attributes, attributes so that the attribute for which the winning probability of a corresponding game content is changed will vary in a periodical manner; and
a providing section that provides a game content selected by the random selection section to the game player, wherein
a life parameter which varies in accordance with a change in a predetermined parameter of the game is set in each of the game contents,
the progress processor excludes, from among a plurality of game contents forming a card group owned by the game player, a game content in which the life parameter is reduced to a predetermined value or lower from the card group,
on the basis of the winning probability set for an attribute of the excluded game content, the winning probability changing processor performs random selection to select a game content having the attribute of the excluded game content in response to a request from the game player, and
the providing section provides the selected game content to the game player.

2. The server device according to claim 1, further comprising:
an image data generator that generates data of an image indicating an attribute of a game content for which the winning probability will be changed after the lapse of a predetermined period from the certain time point and causes a game player terminal to be operated by the game player to display the image before the winning probability is changed.

3. A non-transitory computer-readable storage medium storing a game program which causes an information processing apparatus to execute a game which is played by a game player via a network by using a deck in which a plurality of attributes are set in advance, the deck being organized by using a predetermined number of game contents, an attribute being set in each of the predetermined number of game contents, the game program causing the information processing apparatus to execute:
performing random selection to select a game content on the basis of a predetermined winning probability;
performing processing for progressing the game and calculating a progress rate of the game played by the game player on the basis of a predetermined parameter;
when changing, in accordance with a progress rate of the game played by the game player calculated at a certain time point and in accordance with the attribute, winning probabilities of game contents after the lapse of a predetermined period from the certain time point, setting, according to the attribute, an interval at which the winning probabilities of the game contents are changed and also setting, among the plurality of attributes, attributes so that the attribute for which the winning probability of a corresponding game content is changed will vary in a periodical manner;
excluding, from among a plurality of game contents forming a card group owned by the game player, a game content in which a life parameter which varies in accordance with a change in a predetermined parameter of the game is reduced to a predetermined value or lower from the card group, the life parameter being set in each of the game contents, and on the basis of the winning probability set for an attribute of the excluded game content, performing random selection to select a game content having the attribute of the excluded game content in response to a request from the game player; and
providing the selected game content to the game player.
